(19) United States
(12) Patent Application Publication
(10) Pub. No.: US 2018/0062491 A1
(43) Pub. Date: Mar. 1, 2018

(54) Interstructural and Inertial Actuator

(71) Applicant: John E Miesner, Fairfax, VA (US)

(72) Inventor: John E Miesner, Fairfax, VA (US)

(73) Assignee: United States Department of the Navy, Arlington, VA (US)

(21) Appl. No.: 15/247,058

(22) Filed: Aug. 25, 2016

(51) Int. Cl. H02K 33/02; H02K 1/12; H02K 1/34

(52) U.S. Cl. CPC H02K 33/02; H02K 1/34; H02K 1/12

(57) ABSTRACT

Disclosed is an electrodynamic actuator that simultaneously produces a controlled linear combination of interstructural and inertial forces. Two coil pairs interact with radial or axial permanent magnets. The forces produced in the coil pairs acts between an end of the actuator and a common moveable mass. If the coil pair forces are equal and in the same direction they make the mass move and produce an inertial output force. If the coil pair forces are equal and in opposite directions the mass does not move and interstructural forces are produced between the two ends of the actuator. Combinations of inertial and interstructural forces are produced in a controlled manner by coordinating the electrical current through each coil pair. The actuator efficiency and the low frequency inertial force outputs are greatly improved compared to separate dedicated inertial and interstructural actuators.

### STATEMENT OF GOVERNMENT INTEREST

The invention described herein may be manufactured and used by, or for the Government of the United States of America, for governmental purposes without payment of any royalties thereon or therefore.

### BACKGROUND

Electrodynamic actuators are in widespread use with numerous design variations. For example, U.S. Pat. No. 5,231,336 discloses an electrodynamic actuator that uses dual coaxial coils to produce opposing magnetic fields with a total inductance lower than an equivalent single coil. Permanent magnets produce corresponding radial magnetic fields in close proximity to the coils across a small air gap. The coil current interacts with the magnet field to produce axial forces according to the Lorentz effect. In one embodiment described in U.S. Pat. No, 5,231.336, the coils are wound around a non-magnetic bobbin and are between an axially magnetized permanent magnet structure mounted on a sliding shaft and a magnetically permeable housing. In another embodiment, the coils are wound around a magnetically permeable cylinder mounted on a sliding shaft while the permanent magnets are radially magnetized and mounted on the inner periphery of the housing.

Actuators either apply forces between two parts of a structure to which the actuator is attached in what is known as an “interstructural” design or they accelerate a mass to generate reaction forces into a single attachment point which is called an “inertial” design.

Both interstructural and inertial electrodynamic actuators have been effectively used but each has limitations. Inertial actuators are limited in their low frequency response by the amount of mass that must be accelerated and the maximum displacement available to move the mass. Interstructural actuators can generate lower frequency forces than inertial actuators but, when they are used to apply force to a structure, there will be an equal and opposite force into another part of the structure which may be undesirable. Interstructural and inertial electrodynamic actuators may be used in combination to gain low frequency force capability while eliminating undesired opposing forces. However, employing both interstructural and inertial electrodynamic actuators adds cost and weight to and reduces the efficiency of the design. Therefore, what is needed is an actuator that simultaneously produces a controlled linear combination of interstructural and inertial forces, is reduced in size compared to a two actuator design, and has an improved efficiency.

### SUMMARY

It is an object of the present invention to provide an electrodynamic actuator that simultaneously produces a controlled linear combination of interstructural and inertial forces while being more efficient and compact than having separate interstructural and inertial actuators.

Electro-dynamic actuators operate on the Lorentz principle which states that a current conducting wire in a magnetic field experiences a force perpendicular to both the magnetic field and the direction of current flow. To produce axial forces, the magnetic field is in the radial direction and the current flow is through a circumferential coil.

In the present invention, the magnetic field is produced by permanent magnets on the inside, the outside, or both the inside and the outside of two pairs of current conducting coils. In each pair, the coils are connected such that current flows oppositely (i.e. clockwise in one coil and counterclockwise in the other coil) and reside in directionally opposite radial magnetic fields. Therefore, the axial forces produced by the two coils of a pair are in the same direction, and always add. The forces produced by a coil pair act between an end of the actuator and a common movable mass. If the forces of the two coil pairs are equal and in the same direction, they make the mass move and produce an inertial output force. If the forces of the two coil pairs are equal and in opposite directions, the mass does not move and interstructural forces are produced between the two ends of the actuator. In general, a combination of inertial and interstructural forces is produced in a controlled manner by coordinating the electrical current through each coil pair.

The output force of an electrodynamic actuator may be written as F=GI, where I is the current through the coils and G is a proportionality constant which is a function of frequency. Labeling one coil pair as 1 and the other coil pair as 2, the output inertial force (Fᵢₙₑ) and the output interstructural force (Fᵢₙₜ) of the present invention can be calculated as follows:

$$[ \begin{matrix}{F}_{ine} \\ {F}_{int}\end{matrix} ] = [ \begin{matrix}{G}_{1} & {G}_{2} \\ {G}_{1} & - {G}_{2}\end{matrix} ] [ \begin{matrix}{I}_{2} \\ {I}_{2}\end{matrix} ]$$

The gain matrix

$$[ \begin{matrix}{G}_{1} & {G}_{2} \\ {G}_{1} & - {G}_{2}\end{matrix} ]$$

may be inverted to find the required currents I₁ and I₂ through coil pair 1 and coil pair 2 to produce any linear combination of desired inertial force (Fᵢₙₑ) and interstructural force (Fᵢₙₜ) with the following force to current transformation:

$$[ \begin{matrix}{I}_{1} \\ {I}_{2}\end{matrix} ] = \frac{1}{2} [ \begin{matrix}{G}_{1}^{- 1} & {G}_{1}^{- 1} \\ {G}_{2}^{- 1} & - {G}_{2}^{- 1}\end{matrix} ] [ \begin{matrix}{F}_{ine} \\ {F}_{int}\end{matrix} ]$$

The present invention produces a combination of inertial forces and interstructural forces more efficiently and compactly than separate actuators for each function. This is especially true for broadband force demand which has a peak force that is significantly higher than the Root Mean Square (RMS) force. Both coil pair 1 and coil pair 2 produce inertial forces and interstructural forces according to the above force to current transformation. When a peak occurs in either the inertial force demand or the interstructural force demand, both coil pair 1 and coil pair 2 produce a force which has the effect of flattening the peak coil current of each and reducing the RMS current. Reduced RMS current indicates increased efficiency. It should also be noted that the output of an inertial actuator is fundamentally limited by the amount of moving mass and the distance that it moves. In the present invention, the majority of the actuator mass is moveable and produces low frequency force. In contrast, with separate actuators, only the inertial actuator mass is movable while the interstructural actuator mass is stationary. Thus, this invention is more effective at producing low frequency inertial forces than a dedicated inertial actuator.

There are multiple preferred embodiments of the present invention. In each embodiment, there are two coil pairs that reside in radial magnetic fields and which produce axial forces in response to current flow. The two coils of each pair are connected to have electric current flow in opposite directions. When current flows through the coils, axial forces are created by the Lorentz principle. The direction of magnetic flux for each coil of a pair is opposite the other coil and the direction of current flow is also opposite the other. Therefore, axial forces created by each coil of a pair are in the same direction and the forces add. Radial magnetic fields are produced by radial magnet rings, axial magnets, or a combination of the two. In each embodiment, there is one moveable part which is slidably supported by hearings and which has springs for returning to the neutral position. Also, there are two stationary parts each of which is attached to one end of the actuator. The coil pairs and the magnets are mounted to the moveable part or the stationary parts depending on the embodiments. In all embodiments, the forces produced in the coil pairs are transferred to opposite ends of the actuator and the total moveable mass produces the inertial force.

In one embodiment of the present invention, the two coil pairs are wound onto two heat conducting armatures each of which is attached to one end of the actuator. The heat conducting armatures provide mechanical support to the current conducting coils and transfer heat from the coils directly to the attachment point. Two inner and two outer radially polarized, permanent magnet ring pairs are aligned and fixed in position relative to each other by inner and outer flux returns which are attached together. The entire magnet and flux return assembly moves as a unit relative to the two fixed coil pairs. The radial magnet rings of each pair are polarized opposite each other. The inner and outer rings of like polarization are aligned and reinforce each other to produce a high radial magnetic field in the gap between them in which the coil pairs reside.

In another embodiment, the two coil pairs are each wound onto a heat conducting armature as in the first embodiment. The two inner radial magnet ring pairs of the first embodiment are replaced with two axially polarized magnets which are polarized in opposite directions to each other. The two inner axially polarized magnets and two outer radially polarized magnet ring pairs are aligned and fixed in position relative to each other by inner and outer flux returns which are attached together. The entire magnet and flux return assembly moves as a unit relative to the two fixed coil pairs. The radial magnet rings of each pair are polarized opposite each other. The two inner axially polarized magnet ring pairs and two outer radially polarized magnet ring pairs reinforce each other to produce a high radial magnetic field in the gap between them in which the coil pairs reside.

In a third embodiment of the present invention, the two coil pairs are in contact with and attached to the outer flux return which provides mechanical support and transfers heat from the coils. The coils move with the outer flux return. Two inner radially polarized permanently magnetic ring pairs are attached to inner flux returns, one of which is attached to each end of the actuator. The outer flux return completes the flux path for the inner radial magnets and moves relative to the magnets. The two inner radially polarized magnet ring pairs produce a high radial magnetic field in which the coil pairs reside.

In a fourth embodiment of the present invention, the two coil pairs are in contact with and attached to the outer flux return as in the previous embodiment. The two inner radial magnet ring pairs of the third embodiment are replaced with two axially polarized magnets which are polarized in opposite directions to each other and which are attached to opposite ends of the actuator. The two inner axially polarized magnets produce a high radial magnetic field in which the coil pairs reside.

In yet another embodiment of the present invention, the two coil pairs are in to contact with and attached to inner flux returns, one of which is attached to each end of the actuator. Two outer radially polarized permanent magnet ring pairs are attached to the outer flux return. The entire magnet and flux return assembly moves as a unit relative to the two fixed coil pairs. The inner flux return completes the flux path for the outer radial magnets. The two outer radially polarized magnet ring pairs produce a high radial magnetic field in which the coil pairs reside.

### DRAWINGS

FIG. 1 is a cross-sectional view of a first embodiment of the present invention.

FIG. 2 is an exploded component view of a first embodiment of the present invention.

FIG. 3 shows the calculated magnetic flux lines with no drive current for a first embodiment of the present invention.

FIG. 4 is a schematic of the signal and current low which illustrates how coil pair 101 and coil pair 102 are driven to achieve a linear combination of inertial and interstructural forces.

FIG. 5a shows an example random force demand for an inertial actuator.

FIG. 5b shows an example random force demand for an interstructural actuator.

FIG. 6a shows the example inertial and interstructural force demands of FIGS. 5a and 5b transformed into force demand for coil pair 101 of the present invention.

FIG. 6b shows the example inertial and interstructural force demands of FIG. 5a and 5b transformed into force demand for coil pair 102 of the present invention.

FIG. 7 shows the calculated magnetic flux lines with no drive current for a second embodiment of the present invention.

FIG. 8 is a cross-sectional view of a third embodiment of the present invention.

FIG. 9 is an exploded component view of a third embodiment of the present invention.

FIG. 10 shows the calculated magnetic flux lines with no drive current for a third embodiment of the present invention.

FIG. 11 shows the calculated magnetic flux lines with no drive current for a fourth embodiment of the present invention,

FIG. 12 shows the calculated magnetic flux lines with no drive current for a fifth embodiment of the present invention.

### DETAILED DESCRIPTION

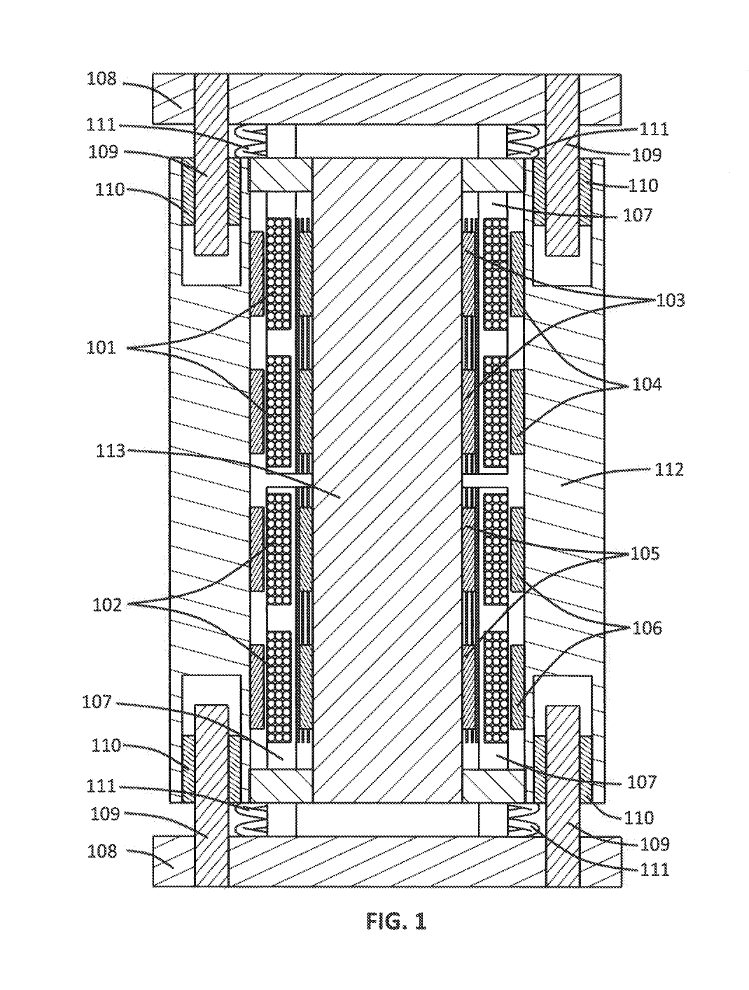

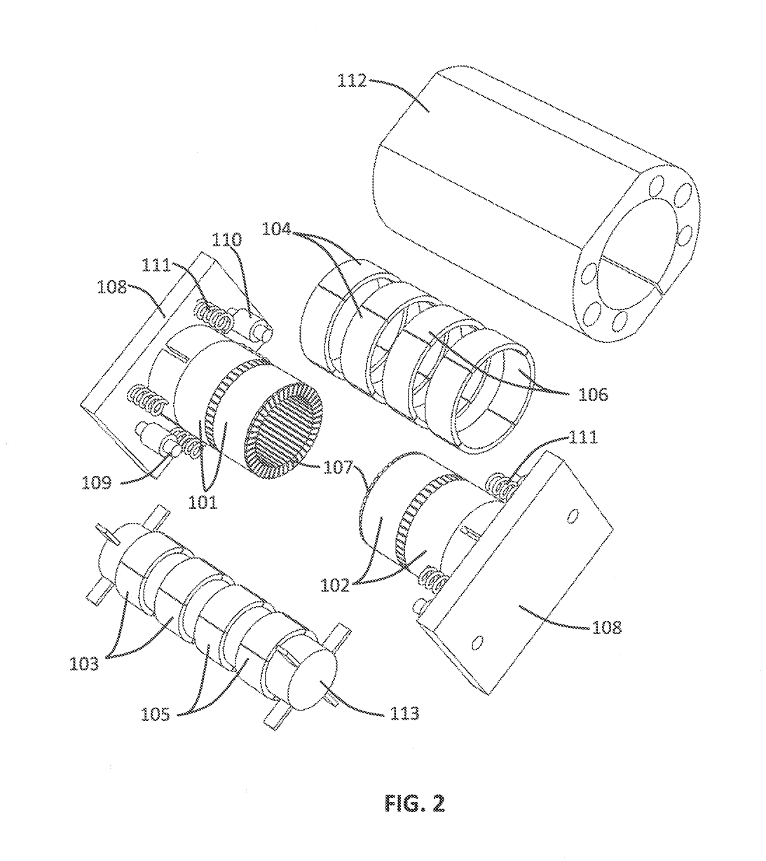

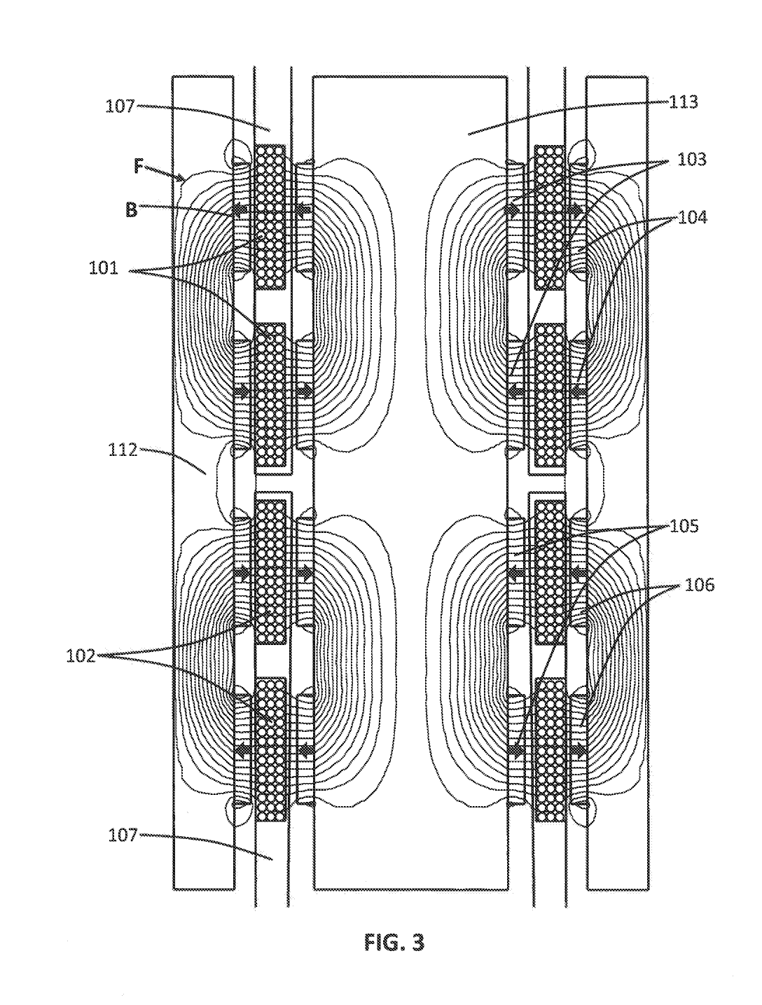

FIGS. 1 and 2 illustrate an embodiment of the interstructural and inertial actuator (actuator) of the present invention. FIG. 1 is a cross-sectional view of the actuator, while FIG. 2 is an exploded component view of the actuator. FIG. 3 shows the magnetic flux lines (F) of the same embodiment of the actuator with no drive current and with assumed magnet polarization directions shown by arrows (B).

Referring to the actuator embodiment in FIGS. 1 and 2, a coil pair (101) is supported by a heat conducting armature (107) which is attached to an actuator end plate (108) at one end of the actuator. Coil pair (102) is also supported by heat conducting armature (107) which is attached to an actuator end plate (108) at the opposite end of the actuator. Consequently, forces generated in coil pairs (101) and (102) are transferred to opposite ends of the actuator. The two coils of each pair are connected to have electric current flow in opposite directions. So, if current is flowing clockwise through one coil then it will be flowing counterclockwise in the other coil. The coils of a pair may be connected in series or parallel as long as the current flow is equal and in opposite directions.

Inner radial magnet ring pair (103) and inner radial magnet ring pair (105) are attached to inner flux return (113). Outer radial magnet ring pair (104) and outer radial magnet ring pair (106) are attached to outer flux return (112). The inner and outer flux returns (113) and (112) are attached to each other and move as a unit relative to coil pairs (101) and (102). Inner radial magnet ring pair (103) and outer radial magnet ring pair (104) are axially aligned with each other. Likewise inner radial magnet ring pair (105) and outer radial magnet ring pair (106) are axially aligned with each other. The magnet rings of each pair are polarized opposite to each other as shown in FIG. 3 by arrows B. Therefore, if one of the magnet rings of the magnet ring pair (103) is polarized outward, as shown in FIG. 3, then the other magnet ring of the pair (103) is polarized inward. The axially aligned magnetic rings are polarized in the same direction. So, if a magnet ring of pair (103) is polarized outward as shown in FIG. 3, then the magnet ring of pair (104) that is axially aligned with that ring of pair (103) is also polarized outward. The effect is to create strong radial magnetic fields, shown by lines of flux F, between the inner flux return (113) and outer flux returns (112) that pass through coil pairs (101) and (102). When current flows through the coils, axial forces are created by the Lorentz principle. The direction of magnetic flux for each coil of a pair is opposite the other coil and the direction of current flow is also opposite the other. Therefore axial forces created by each coil of a pair are in the same direction and the forces add.

Outer flux return (112) is slidably mounted onto the two actuator end plates (108) by bearings (110) sliding on bearing shafts (109). Springs (111) provide a return force between outer flux return (112) and the actuator end plates (108). The outer flux return (112), the magnet ring pairs (103), (104), (105), and (106), and the inner flux return (113) constitute the inertial reaction mass of the actuator.

The heat conducting armatures (107) are preferably made of a non-magnetic material with a high thermal conductivity such as aluminum. Such materials also have a high electrical conductivity. Therefore a solid armature would have eddy currents induced both by the fluctuating magnetic fields from the current conducting coils and by the relative motion of the permanent magnet fields. The armatures (107) of the present invention include vertical slits that prevent significant eddy currents from being induced while allowing heat flow in the axial direction.

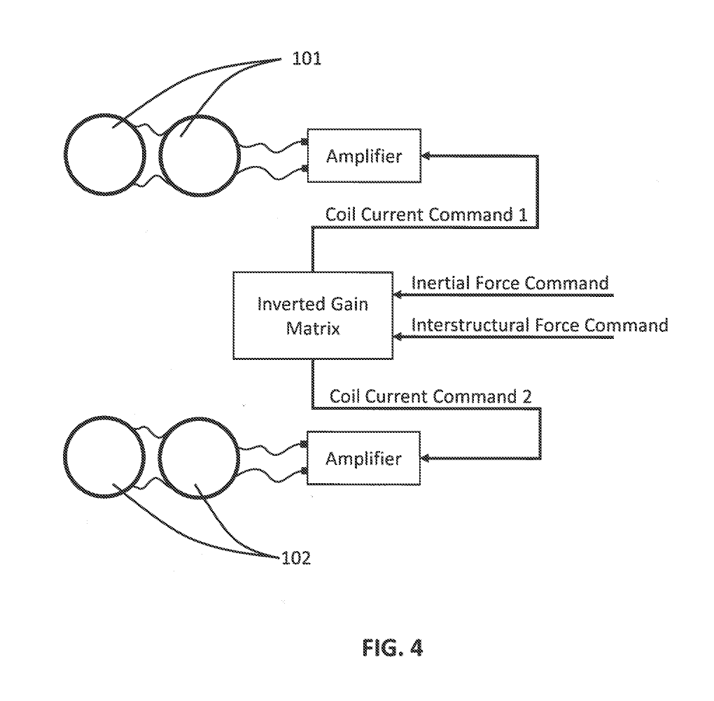

FIG. 4 is a schematic of the signal and current flow that illustrates how coil pair (101) and coil pair (102) are driven to achieve a linear combination of inertial and interstructural forces. An input inertial force command and an input interstructural force command, which are independent and arbitrary, are multiplied by the inverted gain matrix which transforms them into coil current commands 1 and 2. Coil current command 1 goes to an amplifier that produces current through coil pair (101) and coil current command 2 goes to another amplifier that produces current through coil pair (102). The coil pairs (101) and (102) produce axial forces in response to the current. The portion of the coil pairs forces that are in the same direction produce a combined inertial output force which is equal to the input inertial force command. The portion of the coil pairs forces that are in opposite directions produce a combined interstructural output force which is equal to the input interstructural force command.

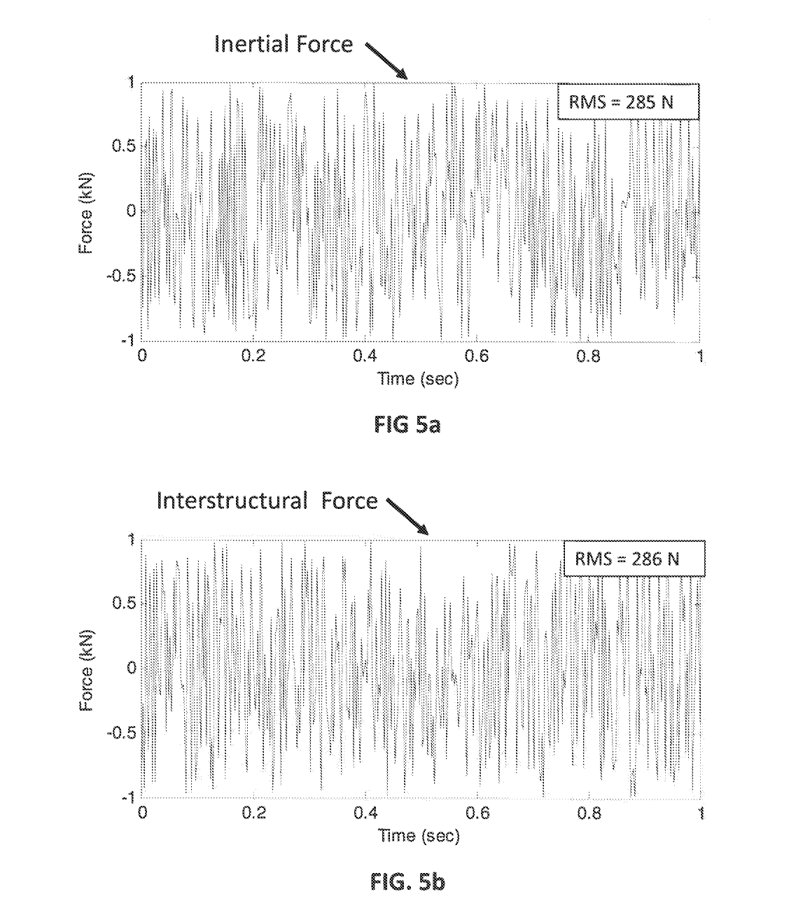

FIGS. 5a and 5b illustrate an example of random inertial and interstructural demand forces. If separate inertial and interstructural actuators were designed to produce these forces as in the current art, then the inertial actuator would have to produce an RMS force of 285N as shown in FIG. 5a and a separate interstructural actuator would have to produce an RMS force of 286 N as shown in FIG. 5b.

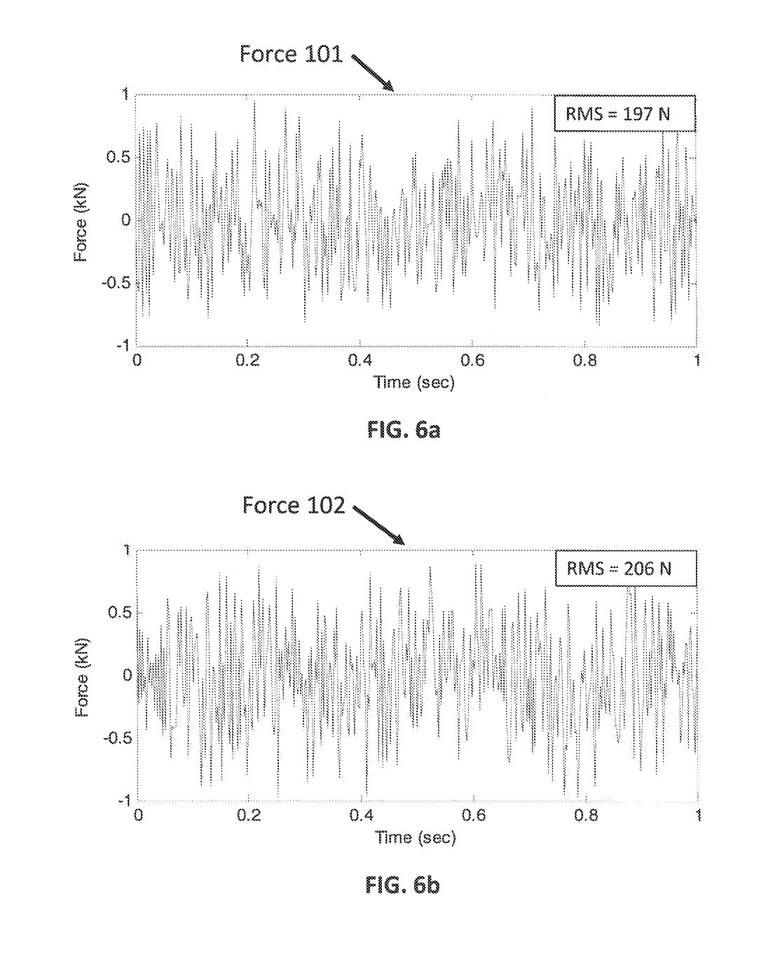

FIGS. 6a and 6b illustrate the effect of transforming the demand forces of FIGS. 5a and 5b to coil pair (101) and coil pair (102) of the actuator of the current invention as illustrated in FIG. 4. In this example, coil pair (101) has to produce an RMS force of 197 N as shown in FIG. 6a and coil pair (102) has to produce an RMS force of 206 N as shown in FIG. 6b. The total RMS force is 403 N for the present invention rather than the 571 N of the prior art, for an efficiency improvement of 29%.

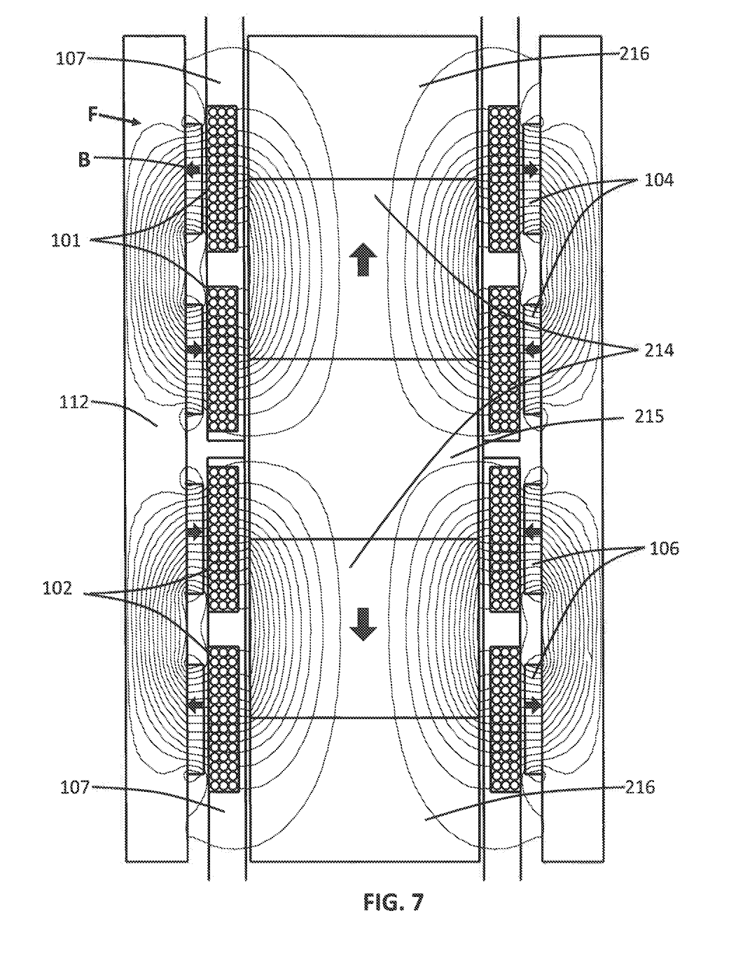

FIG. 7 illustrates the calculated magnetic flux lines F with no drive current for a second embodiment of the present invention. The assumed magnet polarization direction is shown by arrows B. Compared to the first embodiment, this embodiment replaces the inner flux return (113) and inner radial magnet ring pairs (103) and (105) with axially polarized magnets (214), center support (215), and two end supports (216). Axially polarized magnets (214) are polarized opposite to each other as shown by arrows B. The magnetic flux of the first axially polarized magnet (214) combines with the magnetic flux of outer radial magnet ring pair (104). The magnetic flux of the second axially polarized magnet (214) combines with the magnetic flux of outer radial magnet ring pair (106). The effect is to create strong radial magnetic fields, shown by lines of flux (F), through coil pairs (101) and (102). All other aspects of this embodiment are the same as the first embodiment.

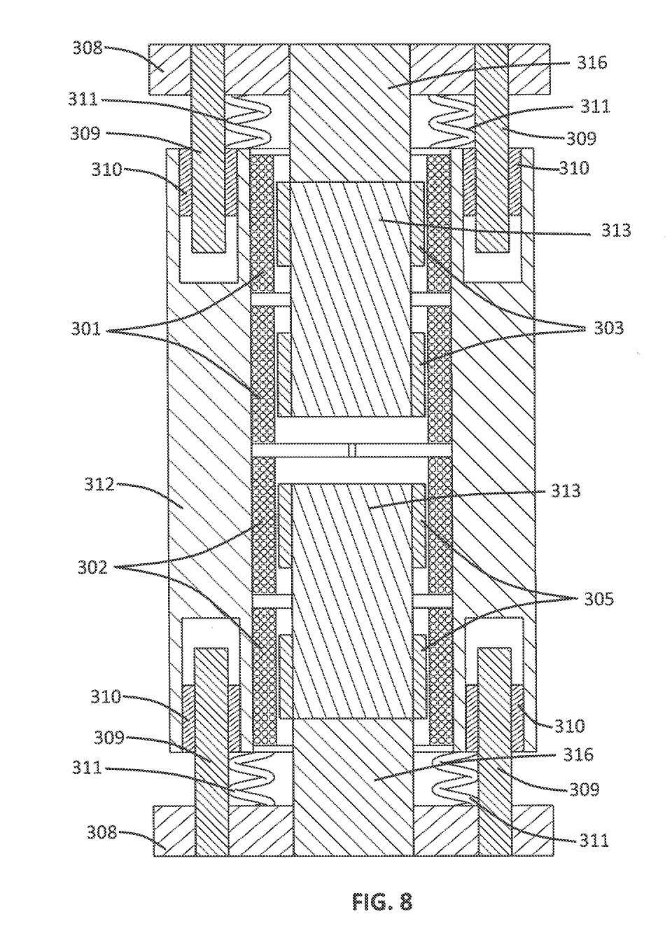

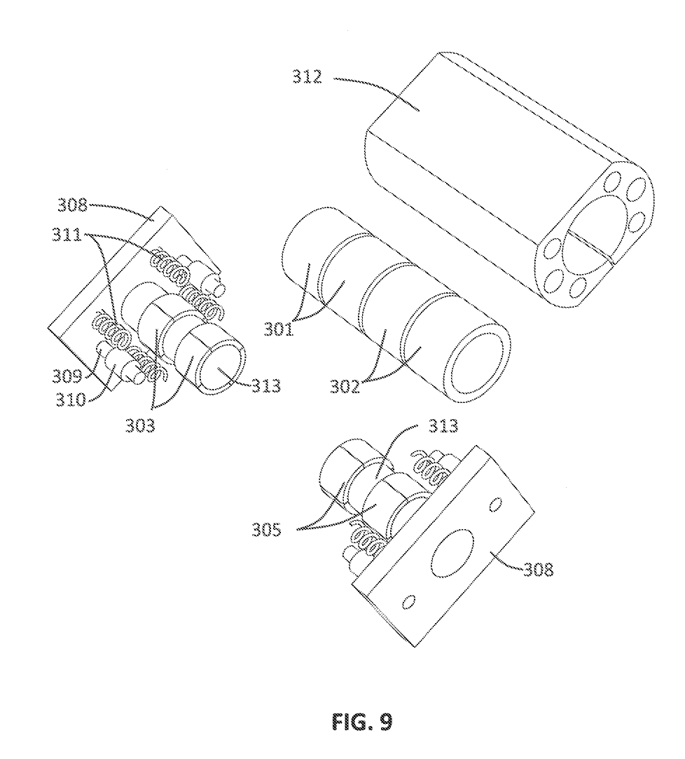

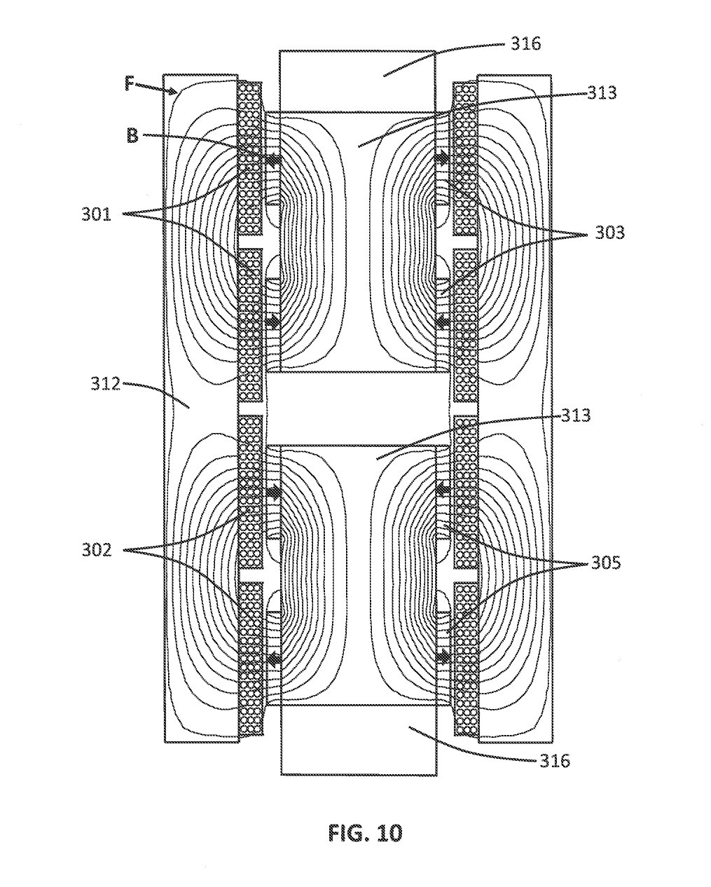

FIGS. 8 and 9 are views of a third embodiment of the present invention. FIG. 8 is a cross-sectional view of the actuator embodiment, while FIG. 9 is an exploded component view. FIG. 10 illustrates the calculated magnetic flux lines (F) with no drive current, and with assumed magnet polarization directions shown by arrows B.

Referring to FIGS. 8 and 9, coil pair (301) and coil pair (302) are supported by outer flux return (312). The two coils of each pair are connected to have electric current flow in opposite directions. So, if current is flowing clockwise through one coil of the pair (301) then it will be flowing counterclockwise in the other coil of the pair (301), as shown in FIG. 10. The coils of a pair may be connected in series or parallel as long as the current flow is equal and in opposite directions.

Inner radial magnet ring pair (303) and inner radial magnet ring pair (305) are each attached to one of the two inner flux returns (313). The Magnet rings of each pair are polarized opposite each other as shown in FIG. 10 by arrows (B). Therefore, if one magnet ring of the pair (303) is polarized outward as shown in FIG. 10 then the other magnet ring of the pair (303) is polarized inward. Outer flux return (312) completes the flux path for the inner radial magnet ring pairs (303) and (305). The effect is to create strong radial magnetic fields, shown by lines of flux (F), between the inner flux return (313) and outer flux returns (312) that pass through coil pairs (301) and (302). When current flows through the coils, axial forces are created by the Lorentz principle. The direction of magnetic flux and current flow for each coil of a pair is opposite the other coil. Therefore axial forces created by each coil of a pair are in the same direction and the forces add.

Outer flux return (312) is slidably mounted to the two actuator end plates (308) by bearings (310) sliding on bearing shafts (309). Springs (311) provide a return force between outer flux return (312) and the actuator end plates (308). The outer flux return (312) and coil pairs (301) and (302) constitute the inertial reaction mass of the actuator.

Each inner flux return (313) is attached to an end support (316) which is attached to an actuator end plate (308). When Lorentz forces are generated in coil pairs (301) and (302), equal and opposite forces are generated in the inner radial magnet ring pairs (303) and (305). These forces are transferred to the actuator end plates (308).

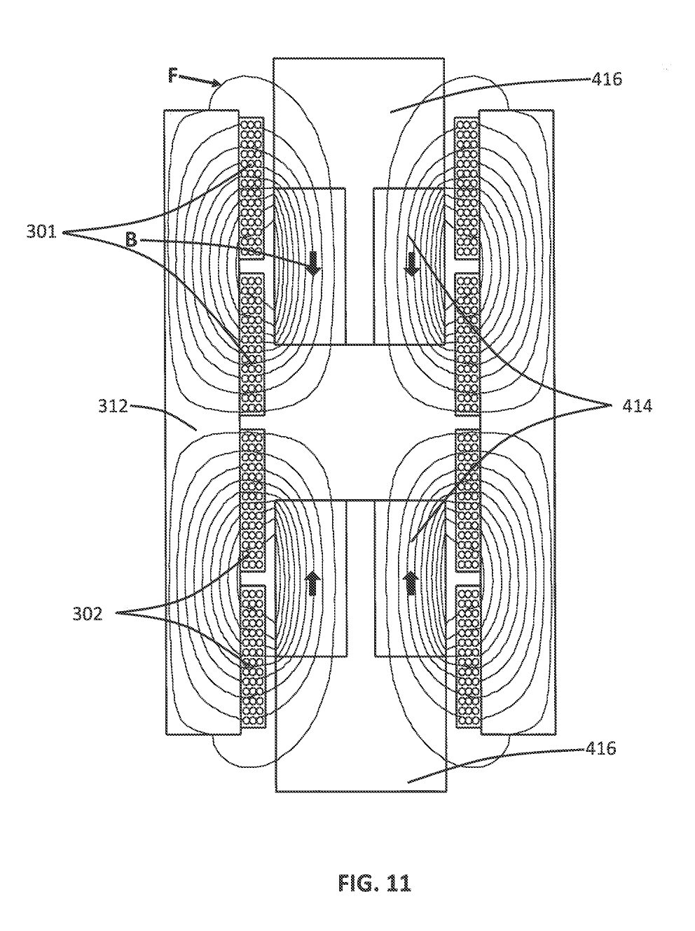

FIG. 11 illustrates the calculated magnetic flux lines (F) with no drive current for a fourth embodiment of the present invention. The assumed magnet polarization direction is shown by arrows B. Compared to the third embodiment, the fourth embodiment replaces the inner flux returns (313) and inner radial magnet ring pairs (303) and (305) with axially polarized magnet pair (414) and the two end supports (416). The two axially polarized magnets of the pair (414) are polarized opposite to each other as shown in FIG. 11 by arrows B. Outer flux return (312) completes the flux path for axially polarized magnets (414). The effect is to create strong radial magnetic fields as shown by the lines of flux (F) that pass through coil pairs (301) and (302). All other aspects of the fourth embodiment are the same as the third embodiment.

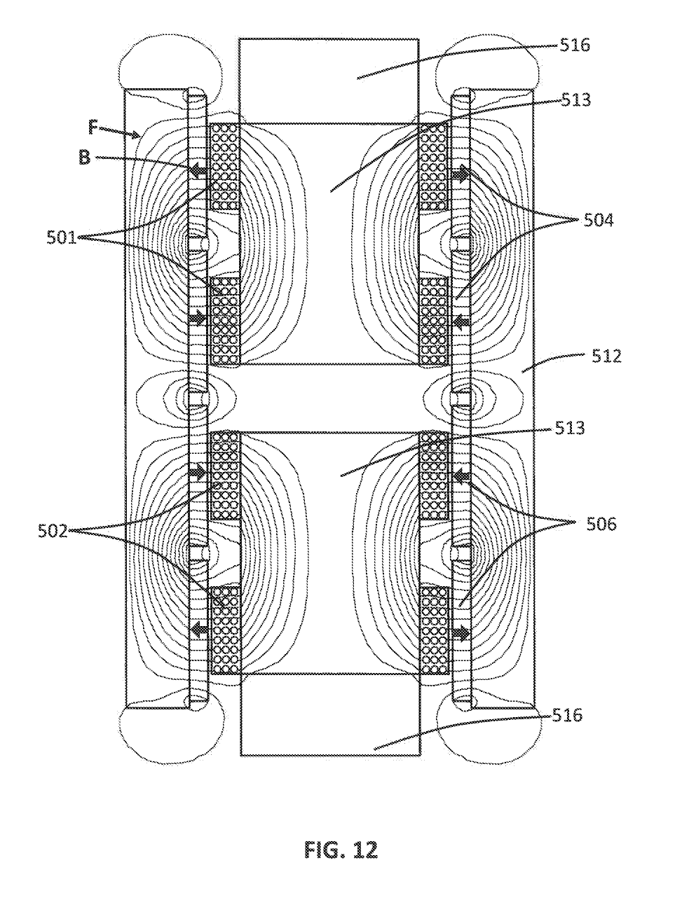

FIG. 12 illustrates the calculated magnetic flux lines (F) with no drive current for the fifth embodiment of the present invention. The assumed magnet polarization direction is shown by arrows B. Compared to the third embodiment, the fifth embodiment has inner coils and outer magnet rings. Coil pair (501) and coil pair (502) are each attached to one of the two inner flux returns (513). The two coils of each pair are connected to have electric current flow in opposite directions. That is, if current is flowing clockwise through one coil of the pair (501) then it will be flowing counterclockwise in the other coil of the pair (501). The coils of a pair may be connected in series or parallel as long as the current flow is equal and in opposite directions.

Outer radial magnet ring pair (504) and outer radial magnet ring pair (506) are each attached to outer flux return (512). The magnet rings of each pair are polarized opposite of each other as shown in FIG. 12 by arrows (B). If one of the magnet rings of the pair (504) is polarized outward as shown in FIG. 12, then the other magnet ring of the pair (504) is polarized inward. Inner flux returns (513) complete the flux path for the outer radial magnet ring pairs (504) and (506). The effect is to create strong radial magnetic fields, shown by lines of flux (F), between the inner and outer flux returns (513) and (512) that pass through coil pairs (501) and (502). When current flows through the coils, axial forces are created by the Lorentz principle. The direction of magnetic flux for each coil of a pair is opposite the other coil. Also, the direction of current flow for each coil of a pair is also opposite the other coil. Therefore, axial forces created by each coil of a pair are in the same direction and the forces add. Each inner flux return (513) is attached to an end support (516) which is attached to an actuator end plate (308). Therefore forces generated in coil pairs (501) and (502) are transferred to opposite ends of the actuator.

Outer flux return (512) is slidably mounted to the two actuator end plates (308) by bearings (310) sliding on bearing shafts (309). Springs (311) provide a return force between outer flux return (312) and the actuator end plates (308). The outer flux return (512) and magnet pairs (504) and (506) constitute the inertial reaction mass of the actuator.

Although the invention has been described in detail with particular reference to these preferred embodiments, other embodiments can achieve the same results. Variations and modifications of the present invention will be obvious to those skilled in the art and it is the intent of this application to cover, in the appended claims, all such modification and equivalents. The entire disclosure and all references, applications, patents and publications cited above are hereby incorporated by reference

What is claimed is:

1. An electrodynamic actuator comprising:
a first coil pair;
a second coil pair;
a first heat conducting armature, with a first end and a second end, that supports the first coil pair;
a second heat conducting armature, with a first end and a second end, that supports the second coil pair;
a first actuator end plate attached to the first end of the first heat conducting armature;
a second actuator end plate attached to the first end of the second heat conducting armature;
an inner flux return;
a first inner radial magnet ring pair attached to the inner flux return;
a second inner radial magnet ring pair attached to the inner flux return;
an outer flux return, attached to and surrounding the inner flux return, with a first end and a second end, wherein the first end is slidably mounted to the first actuator end plate by bearings sliding on bearing shafts mounted to the first actuator end plate and wherein the second end is slidably mounted to the second actuator end plate by bearings sliding on bearing shafts mounted to the second actuator end plate;
a first outer radial magnet ring pair attached to the outer flux return;
a second outer radial magnet ring pair attached to the outer flux return; and
springs between the first actuator end plate and the second actuator end plate to provide a return force between the outer flux return and the actuator end plate.

2. The electrodynamic actuator of claim 1, wherein coils of the first coil pair are connected to have electric current flow equally in opposite directions.

3. The electrodynamic actuator of claim 1 wherein coils of the second coil pair are connected to have electric current flow equally in opposite directions.

4. The electrodynamic actuator of claim 1, wherein coils of the first coil pair are connected in series and coils of the second coil pair are connected in series.

5. The electrodynamic actuator of claim 1, wherein coils of the first coil pair are connected in parallel and coils of the second coil pair are connected in parallel.

6. The electrodynamic actuator of claim 1, wherein the first inner radial magnet ring pair and the first outer radial magnet ring pair are axially aligned with each other.

7. The electrodynamic actuator of claim 1, wherein the second inner radial magnet ring pair and the second outer radial magnet ring pair are axially aligned with each other.

8. The electrodynamic actuator of claim 1, wherein rings of the first inner radial magnet ring pair are polarized opposite to each other.

9. The electrodynamic actuator of claim 1, wherein rings of the second inner radial magnet ring pair are polarized opposite to each other.

10. The electrodynamic actuator of claim 1, wherein the inner flux return and the outer flux return move as a unit relative to the first and second coil pairs.

11. The electrodynamic actuator of claim 1, wherein the outer flux return, the first inner radial magnet ring pair, the second inner radial magnet ring pair, the first outer radial magnet ring pair, the second outer radial magnet ring pair, and the inner flux return constitute the inertial reaction mass of the actuator.

12. The electrodynamic actuator of claim 1, wherein forces from the first coil pair combine with same direction forces from the second coil pair to produce a controlled inertial force at the first and second end plates, by coordinating electrical current through each coil pair through an inverted gain matrix transformation.

13. The electrodynamic actuator of claim 1, wherein forces from the first coil pair combine with opposite direction forces from the second coil pair to produce a controlled interstructural force at the first and second end plates, by coordinating electrical current through each coil pair through an inverted gain matrix transformation.

14. The electrodynamic actuator of claim 1, wherein the heat conducting armature is made of a non-magnetic material with a high thermal conductivity.

15. The electrodynamic actuator of claim 1, wherein the heat conducting armature includes axial slots that reduce eddy current production

16. An electrodynamic actuator comprising:
a first coil pair;
a second coil pair;
a heat conducting armature, with a first end and a second end, that supports the first coil pair and the second coil pair;
a first actuator end plate attached to the first end of the heat conducting armature;
a second actuator end plate attached to the second end of the second heat conducting armature;
a first end support;
a second end support;
a center support placed between the first end support and the second end support;
a first axially polarized magnet attached between the first end support and the center support;
a second axially polarized magnet attached between the second end support and the center support.
an outer flux return, attached to and surrounding the first end support, the second end support, the center support, the first polarized magnet and the second polarized magnet, with a first end and a second end, wherein the first end is slidably mounted to the first actuator end plate by hearings sliding on bearing shafts mounted to the first actuator end plate and the second end is slidably mounted to the second actuator end plate by bearings sliding on bearing shafts mounted to the second actuator end plate;
a first outer radial magnet ring pair attached to the outer flux return;
a second outer radial magnet ring pair attached to the outer flux return; and.
springs separately connected to the first actuator end plate and to the second actuator end plate to provide a return force between the outer flux return and the actuator end plate,

17. The electrodynamic actuator of claim 16, wherein coils of the first coil pair are connected to have electric current flow equally in opposite directions.

18. The electrodynamic actuator of claim 16 wherein coils of the second coil pair are connected to have electric current flow equally in opposite directions.

19. The electrodynamic actuator of claim 16, wherein coils of the first coil pair are connected in series and coils of the second coil pair are connected in series.

20. The electrodynamic actuator of claim 16, wherein coils of the first coil pair are connected in parallel and coils of the second coil pair are connected in parallel.

21. The electrodynamic actuator of claim 16, wherein the first axially polarized magnet is polarized opposite the second polarized magnet.

22. The electrodynamic actuator of claim 16, wherein the magnetic flux of the first axially polarized magnet combines with the magnetic flux of the first outer radial magnet ring pair creating a strong radial magnetic field through the first coil pair.

23. The electrodynamic actuator of claim 16, wherein the magnetic flux of the second axially polarized magnet combines with the magnetic flux of the second outer radial magnetic ring pair creating a strong radial magnetic field through the second coil pair.

24. The electrodynamic actuator of claim 16, wherein forces from the first coil pair combine with same direction forces from the second coil pair to produce a controlled inertial force at the first and second end plates, by coordinating electrical current through each coil pair through an inverted gain matrix transformation.

25. The electrodynamic actuator of claim 16, wherein forces from the first coil pair combine with opposite direction forces from the second coil pair to produce a controlled interstructural force at the first and second end plates, by coordinating electrical current through each coil pair through an inverted gain matrix transformation.

26. The electrodynamic actuator of claim 16, wherein the heat conducting armature is made of a non-magnetic material with a high thermal conductivity.

27. The electrodynamic actuator of claim 16, wherein the heat conducting armature includes axial slots that reduce eddy current production

28. An electrodynamic actuator comprising:
a first inner flux return with a first end and a second end;
a first inner radial magnet ring pair attached around the first inner flux return;
a second inner flux return with a first end and a second end;
a second inner radial magnet ring pair attached around the second inner flux return;
a first actuator end plate attached to the first end of first inner flux return;
a second actuator end plate attached to the first end of the second inner flux return;
a first coil pair;
a second coil pair;
an outer flux return, with a first end and a second end, that surrounds and supports the first and second coil pair, wherein the first end of the outer flux return is slidably mounted to the first actuator end plate by bearings sliding on bearing shafts mounted to the first actuator end plate and the second end is slidably mounted to the second actuator end plate by bearings sliding on bearing shafts mounted to the second actuator end plate; and
springs separately attached to the first actuator end plate and the second actuator end plate to provide a return force between the outer flux return and the actuator end plates.

29. The electrodynamic actuator of claim 28, wherein coils of the first coil pair are connected to have electric current flow equally in opposite directions.

30. The electrodynamic actuator of claim 28, wherein coils of the second coil pair are connected to have electric current flow equally in opposite directions.

31. The electrodynamic actuator of claim 28, wherein coils of the first coil pair are connected in series and coils of the second coil pair are connected in series.

32. The electrodynamic actuator of claim 28, wherein coils of the first coil pair are connected in parallel and coils of the second coil pair are connected in parallel.

33. The electrodynamic actuator of claim 28, wherein rings of the first inner radial magnet ring pair are polarized opposite to each other.

34. The electrodynamic actuator of claim 28, wherein rings of the second inner radial magnet ring pair are polarized opposite to each other.

35. The electrodynamic actuator of claim 28 wherein the outer flux return completes a flux path for the first and second inner radial magnet ring pairs.

36. The electrodynamic actuator of claim 28, wherein the outer flux return, the first coil pair, and the second coil pair constitute an inertial reaction mass of the actuator.

37. The electrodynamic actuator of claim 28, wherein forces from the first coil pair combine with same direction forces from the second coil pair to produce a controlled inertial force at the first and second end plates, by coordinating electrical current through each coil pair through an inverted gain matrix transformation.

38. The electrodynamic actuator of claim 28, wherein forces from the first coil pair combine with opposite direction forces from the second coil pair to produce a controlled interstructural force at the first and second end plates, by coordinating electrical current through each coil pair through an inverted gain matrix transformation.

39. An electrodynamic actuator comprising:
a first axially polarized magnet;
a first end support attached to the first axially polarized magnet;
a second axially polarized magnet;
a second end support attached to the second axially polarized magnet;
a first actuator end plate attached to the first end support;
a second actuator end plate attached to the second end support;
a first coil pair;
a second coil pair;
an outer flux return, with a first end and a second end, that surrounds and supports the first coil pair and the second coil pair, wherein the first end of the outer flux return is slidably mounted to the first actuator end plate by bearings sliding on bearing shafts mounted to the first actuator end plate and the second end is slidably mounted to the second actuator end plate s by bearings sliding on bearing shafts mounted to the second actuator end plate; and
springs separately attached to the first actuator end plate and the second actuator end plate to provide a return force between the outer flux return and the actuator end plates.

40. The electrodynamic actuator of claim 39 wherein coils of the first coil pair are connected to have electric current flow equally in opposite directions.

41. The electrodynamic actuator of claim 39 wherein coils of the second coil pair are connected to have electric current flow equally in opposite directions.

42. The electrodynamic actuator of claim 39, wherein coils of the first coil pair are connected in series and coils of the second coil pair are connected in series.

43. The electrodynamic actuator of claim 39, wherein coils of the first coil pair are connected in parallel and coils of the second coil pair are connected in parallel.

44. The electrodynamic actuator of claim 39, wherein the first axially polarized magnet is polarized opposite the second axially polarized magnet.

45. The electrodynamic actuator of claim 39, wherein the outer flux return completes a flux path for the first and second axially polarized magnets.

46. The electrodynamic actuator of claim 39, wherein forces from the first coil pair combine with same direction forces from the second coil pair to produce a controlled inertial force at the first and second end plates, by coordinating electrical current through each coil pair through an inverted gain matrix transformation.

47. The electrodynamic actuator of claim 39, wherein forces from the first coil pair combine with opposite direction forces from the second coil pair to produce a controlled interstructural force at the first and second end plates, by coordinating electrical current through each coil pair through an inverted gain matrix transformation.

48. An electrodynamic actuator comprising;
a first inner flux return;
a first coil pair attached around the first inner flux return;
a first end support attached to the first inner flux return;
a second inner flux return;
a second coil pair attached around the second inner flux return;
a second end support attached to the second inner flux return;
a first actuator end plate attached to the first end support;
a second actuator end plate attached to the second end support;
an outer flux return, with a first end and a second end, that surrounds the first coil pair, wherein the first end of the outer flux return is slidably mounted to the first actuator end plate by bearings sliding on bearing shafts mounted to the first actuator end plate and the second end is slidably mounted to the second actuator end plate by bearings sliding on bearing shafts mounted to the second actuator end plate;
a first pair of outer radial magnet rings attached to the outer flux return;
a second pair of outer radial magnet rings attached to the outer flux return; and
springs separately attached to the first actuator end plate and the second actuator end plate to provide a return force between the outer flux return and the actuator end plates.

49. The electrodynamic actuator of claim 48, wherein coils the first coil pair are connected to have electric current flow in opposite directions.

50. The electrodynamic actuator of claim 48, wherein coils the second coil pair are connected to have electric current flow in opposite directions.

51. The electrodynamic actuator of claim 48, wherein coils of the first coil pair are connected in series and coils of the second coil pair are connected in series.

52. The electrodynamic actuator of claim 48, wherein coils of the first coil pair are connected in parallel and coils of the second coil pair are connected in parallel.

53. The electrodynamic actuator of claim 48, wherein magnet rings of the first pair of outer radial magnet rings are polarized opposite each other.

54. The electrodynamic actuator of claim 48, wherein magnet rings of the second pair of outer radial magnet rings are polarized opposite each other.

55. The electrodynamic actuator of claim 48, wherein the outer flux return, the first coil pair, and the second coil pair constitute an inertial reaction mass of the actuator.

56. The electrodynamic actuator of claim 48, wherein the first and second inner flux returns complete a flux path for the outer radial magnet ring pairs.

57. The electrodynamic actuator of claim 48, wherein forces from the first coil pair combine with same direction forces from the second coil pair to produce a controlled inertial force at the first and second end plates, by coordinating electrical current through each coil pair through an inverted gain matrix transformation.

58. The electrodynamic actuator of claim 48, wherein forces from the first coil pair combine with opposite direction forces from the second coil pair to produce a controlled interstructural force at the first and second end plates, by coordinating electrical current through each coil pair through an inverted gain matrix transformation.
